(19) United States
(12) Patent Application Publication
(10) Pub. No.: US 2024/0037436 A1
(43) Pub. Date: Feb. 1, 2024

(54) SYSTEM FOR PROCESSING QUANTUM TASK, METHOD FOR PROCESSING QUANTUM TASK AND RELATED APPARATUSES

(71) Applicant: Beijing Baidu Netcom Science Technology Co., Ltd., Beijing (CN)

(72) Inventors: Zelin MENG, Beijin (CN); Shusen LIU, Beijing (CN); Xueyi GUO, Beijing (CN); Zixian YAN, Beijing (CN); Wenxue ZHANG, Beijing (CN); Yang HE, Beijing (CN)

(21) Appl. No.: 18/483,184

(22) Filed: Oct. 9, 2023

(30) Foreign Application Priority Data
Feb. 9, 2023 (CN) 202310134319.2

(51) Int. Cl. G06N 10/20; G06F 9/50

(52) U.S. Cl. CPC G06N 10/20; G06F 9/5027

(57) ABSTRACT

A system for processing a quantum task, a method, a device and a storage medium are provided. The system includes: a user terminal, configured to acquire basic measurement and control parameters of a superconducting quantum computer, generate a quantum task consisting of a quantum pulse and a quantum pulse gate based on the basic measurement and control parameters and an intended task purpose, and send the quantum task to a quantum hardware client; the quantum hardware client, configured to parse the quantum task into a queue of quantum pulses arranged in a time sequence, and send the queue of quantum pulses to the superconducting quantum computer; and the superconducting quantum computer, configured to execute quantum pulse instructions in the queue of quantum pulses in the time sequence, and return an obtained task result to the user terminal.

### CROSS-REFERENCE TO RELATED APPLICATIONS

The present application claims the priority of Chinese Patent Application No. 202310134319.2, titled “SYSTEM FOR PROCESSING QUANTUM TASK, METHOD FOR PROCESSING QUANTUM TASK AND RELATED APPARATUSES”, filed on Feb. 9, 2023, the content of which is incorporated herein by reference in its entirety.

### TECHNICAL FIELD

The present disclosure relates to the field of quantum computing technology, in particular to the technical fields of quantum computers, quantum gate circuits, and quantum pulses, and more particularly, to a system for processing a quantum task and a method for processing a quantum task, as well as to an electronic device, and a computer readable storage medium that are compatible with the method for processing a quantum task.

### BACKGROUND

Quantum computing is a model of computing that follows quantum mechanics and regulates quantum information units to perform calculations. Compared to traditional computers, quantum computing is superior to traditional general-purpose computers in dealing with certain problems.

In quantum computing, superconducting quantum computers have become one of the mainstream quantum computing implementation schemes in the industry.

### SUMMARY

Embodiments of the present disclosure propose a system for processing a quantum task, a method and apparatus for processing a quantum task, an electronic device, and a computer readable storage medium.

In a first aspect, an embodiment of the present disclosure proposes a system for processing a quantum task, including: a user terminal, configured to acquire basic measurement and control parameters of a superconducting quantum computer; generate a quantum task consisting of a quantum pulse and a quantum pulse gate based on the basic measurement and control parameters and an intended task purpose; where the quantum pulse gate is obtained by encapsulating an underlying-level pulse form corresponding to a quantum gate circuit at a logic level; and send the quantum task to a quantum hardware client; the quantum hardware client, configured to parse the quantum task into a queue of quantum pulses arranged in a time sequence, and send the queue of quantum pulses to the superconducting quantum computer; and the superconducting quantum computer, configured to execute quantum pulse instructions in the queue of quantum pulses in the time sequence, and return an obtained task result to the user terminal.

In a second aspect, an embodiment of the present disclosure proposes a method for processing a quantum task, applied to a user terminal, which includes: acquiring basic measurement and control parameters of a superconducting quantum computer; generating a quantum task consisting of a quantum pulse and a quantum pulse gate based on the basic measurement and control parameters and an intended task purpose; wherein the quantum pulse gate is obtained by encapsulating an underlying-level pulse form corresponding to a quantum gate circuit at a logic level; and sending the quantum task to a quantum hardware client, and receiving a task result returned by the superconducting quantum computer after the superconducting quantum computer executes a quantum pulse sequence obtained by parsing the quantum task by the quantum hardware client.

In a third aspect, an embodiment of the present disclosure proposes a method for processing a quantum task, applied to a quantum hardware client, which includes: receiving a quantum task transmitted by a user terminal; wherein the quantum task is generated by the user terminal based on basic measurement and control parameters of a superconducting quantum computer and an experimental purpose of the user terminal, the quantum task consists of a quantum pulse and a quantum pulse gate, and the quantum pulse gate is obtained by encapsulating an underlying pulse form corresponding to a quantum gate circuit at a logic level; and parsing the quantum task into a queue of quantum pulses arranged in a time sequence, and sending the queue of quantum pulses to the superconducting quantum computer, so as to enable the superconducting quantum computer to execute quantum pulse instructions in the queue of quantum pulses sequentially to obtain a task result.

In a fourth aspect, an embodiment of the present disclosure proposes a method for processing a quantum task, applied to a superconducting quantum computer, which includes: sending basic measurement and control parameters to a user terminal initiating a quantum task request; receiving a queue of quantum pulses transmitted by a quantum hardware client and obtained by parsing a quantum task generated by the user terminal; wherein the quantum task is generated by the user terminal based on the basic measurement and control parameters and an experimental purpose of the user terminal, the quantum task consists of a quantum pulse and a quantum pulse gate, and the quantum pulse gate is obtained by encapsulating an underlying-level pulse form corresponding to a quantum gate circuit at a logic level; and executing quantum pulse instructions in the queue of quantum pulses in a time sequence, and returning an obtained task result to the user terminal.

In a fifth aspect, an embodiment of the present disclosure proposes an electronic device including at least one processor; and a memory communicatively connected to the at least one processor, where the memory stores instructions executable by the at least one processor, and the instructions, when executed by the at least one processor, cause the at least one processor to perform the method for processing a quantum task according to the first aspect.

In a sixth aspect, an embodiment of the present disclosure proposes an electronic device including at least one processor; and a memory communicatively connected to the at least one processor, where the memory stores instructions executable by the at least one processor, and the instructions, when executed by the at least one processor, cause the at least one processor to perform the method for processing a quantum task according to the second aspect.

In a seventh aspect, an embodiment of the present disclosure proposes an electronic device including at least one processor; and a memory communicatively connected to the at least one processor, where the memory stores instructions executable by the at least one processor, and the instructions, when executed by the at least one processor, cause the at least one processor to perform the method for processing a quantum task according to the third aspect.

In an eight aspect, an embodiment of the present disclosure proposes a non-transitory computer readable storage medium storing computer instructions, wherein the computer instructions are used to cause the computer to perform the method for processing a quantum task according to the first aspect and/or the third aspect and/or the fourth aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

Other features, objectives and advantages of the present disclosure will become more apparent, by reading detailed description of non-limiting embodiments with reference to the following accompanying drawings:

FIG. 1 is an example system architecture to which the present disclosure may be applied;

FIG. 2 is a flowchart of a method for processing a quantum task applied to a user terminal provided by an embodiment of the present disclosure;

FIG. 3 is a flowchart of a method for processing a quantum task applied to a quantum hardware client provided by an embodiment of the present disclosure;

FIG. 4 is a schematic flowchart of a method for parsing a quantum task provided by an embodiment of the present disclosure;

FIG. 5 is a flowchart of a method for processing a quantum task applied to a superconducting quantum computer provided by an embodiment of the present disclosure;

FIG. 6 is a diagram of a dependency relationship of data dependency relationships between functional modules provided by an embodiment of the present disclosure;

FIG. 7-1 is a schematic diagram of a framework of a device and functional modules contained therein provided by an embodiment of the present disclosure;

FIG. 7-2 is a schematic diagram of execution steps at a user terminal provided by an embodiment of the present disclosure;

FIG. 7-3 is a schematic diagram of execution steps at a quantum hardware client provided by an embodiment of the present disclosure;

FIG. 8 is a structural block diagram of an apparatus for processing a quantum task applied to a user terminal provided by an embodiment of the present disclosure;

FIG. 9 is a structural block diagram of an apparatus for processing a quantum task applied to a quantum hardware client provided by an embodiment of the present disclosure;

FIG. 10 is a structural block diagram of an apparatus for processing a quantum task applied to a superconducting quantum computer provided by an embodiment of the present disclosure; and

FIG. 11 is a schematic structural diagram of an electronic device adapted for performing a method for processing a quantum task provided by an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description. It should be noted that the embodiments and features in the embodiments in the present disclosure may be combined with each other on a non-conflict basis.

In the technical solution of the present disclosure, the collection, storage, use, processing, transmission, provision and disclosure of user personal information involved are all in compliance with relevant laws and regulations, and do not violate public order and good customs.

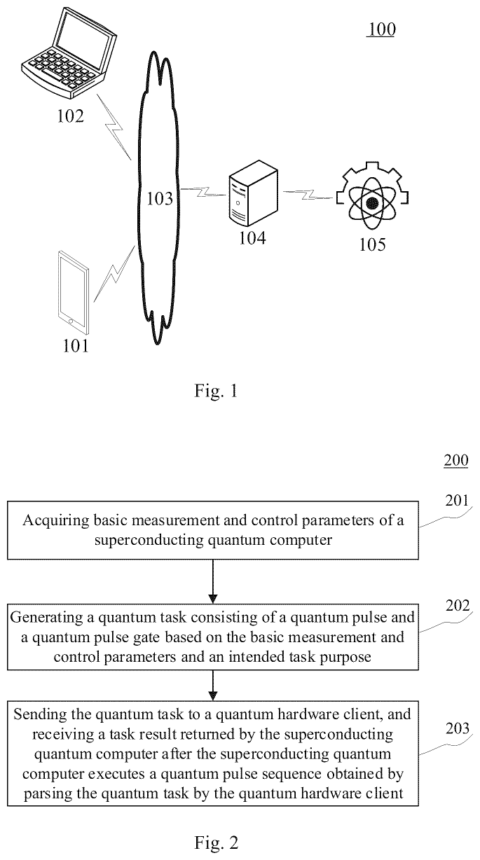

FIG. 1 illustrates an example system architecture 100 to which embodiments of a method and apparatus for processing a quantum task, an electronic device, and a computer readable storage medium of the present disclosure may be applied.

As shown in FIG. 1, the system architecture 100 may include user terminals 101 and 102, a network 103, a quantum hardware client 104, and a superconducting quantum computer 105. The network 103 is used to provide a communication link medium between the user terminals 101, 102 and the quantum hardware client 104. The network 103 may include various types of connections, such as wired, wireless communication links or optic fibers, or may be represented as a data relay station constructed by a data center or a cloud platform.

Users may use the user terminals 101, 102 to interact with the quantum hardware client 104 via the network 103 to receive or send messages, etc. The quantum hardware client 104 usually acts as a pre-processing device for the superconducting quantum computer 105 and is usually in the same position as the superconducting quantum computer 105, and implements data transmission by means of short-range, high-speed, and highly reliable communication. The user terminals 101, 102 and the quantum hardware client 104 may be installed with various applications for implementing information communication therebetween, such as quantum task generation applications, quantum task processing applications, or instant messaging applications.

The user terminals 101, 102, the quantum hardware client 104, and the superconducting quantum computer 105 may be hardware or software. When the user terminals 101, 102 are hardware, they may be various electronic devices having a display screen, including but not limited to smartphones, tablet computers, laptop computers and desktop computers, etc.; when the user terminals 101, 102 are software, they may be installed in the electronic devices listed above, and may be implemented as a plurality of software pieces or software modules, or as a single software piece or software module, which is not limited herein. When the quantum hardware client 104 is hardware, it may be implemented as a distributed server cluster composed of a plurality of servers, or as a single server; when the server is software, it may be implemented as a plurality of software pieces or software modules, or as a single software piece or software module. The superconducting quantum computer 105 may also be represented as a virtual software product in a simulation software or directly represented as a physical device, which is not limited herein.

A system for processing a quantum task constituted based on the user terminals 101, 102, the quantum hardware client 104, and the superconducting quantum computer 105 may realize high controllability of quantum task processing according to the following scheme.

The user terminals 101, 102 first acquire basic measurement and control parameters of the superconducting quantum computer 105 transmitted by the quantum hardware client 104; then, the user terminals 101, 102 generate a quantum task consisting of a quantum pulse and a quantum pulse gate based on the basic measurement and control parameters and an experimental purpose of the user terminal, where the quantum pulse gate is obtained by encapsulating an underlying-level pulse form corresponding to a quantum gate circuit at a logic level; and send the quantum task to the quantum hardware client; then, the user terminals 101, 102 send the quantum task to the quantum hardware client 104.

After performing accompanying compilation and parsing operations on the quantum task, the quantum hardware client 104 processes this quantum task into a queue of quantum pulses arranged in a time sequence, and sends the queue of quantum pulses to the superconducting quantum computer 105.

The superconducting quantum computer 105 executes quantum pulse instructions in the queue of quantum pulses sequentially in the time sequence, to obtain a task result, and returns the task result to the user terminals 101, 102 via the quantum hardware client 104.

Based on the above steps performed by the user terminals, the quantum hardware client and the superconducting quantum computer respectively, by deeply constructing an underlying layer of a quantum, a user may construct the quantum task consisting of a quantum pulse and a quantum pulse gate based on basic measurement and control parameters and an intended task purpose, and at the same time the quantum hardware client at a front-end of the superconducting quantum computer provides a parsing and processing capability matching the quantum task, thus achieving a finer control of execution parameters in the quantum task, enabling superconducting quantum devices to perform the task more accurately according to the quantum pulse instructions, so that a task result is more in line with the user actual needs.

Based on the above embodiment, in some other embodiments of the present disclosure, the basic measurement and control parameters may include: a definition of the quantum pulse gate, time axis arrangement and bit distribution information, the quantum pulse gate is jointly defined by a pulse waveform function and pulse parameters, the pulse waveform function is used to describe a corresponding pulse waveform, and the pulse parameters include: a target frequency of a pulse, an arbitrary waveform generator frequency, a phase, an amplitude scaling coefficient, start time, a duration, and distinctive parameters corresponding to different pulse waveform functions.

Based on the above embodiment, in some other embodiments of the present disclosure, the system for processing a quantum task may further include: a data center arranged at communication links between the user terminals 101, 102 and the quantum hardware client 104.

The data center is configured to forward the basic measurement and control parameters of the superconducting quantum computer transmitted via the quantum hardware client to the user terminal; forward the quantum task received from the user terminal to the quantum hardware client; and forward a task result received from the quantum hardware client to the user terminal.

That is, by arranging the data center between the user terminal and the quantum hardware client as a platform for receiving and transmitting data, the reliability and stability of data transmission may be further guaranteed. Further, the data center provides an external access interface, facilitating fine-tuning and correcting of the received data at the data center.

Based on the previous embodiment, the system for processing a quantum task may further include:
the data center, further configured to create a corresponding task item based on the received quantum task; and adjust an execution state of the corresponding task item based on the received task result; where the execution state includes: a to-be-executed state and an executed state.

That is, the data center is further configured to record the execution state of the quantum task and adjust the task execution state of the corresponding quantum task based on the received data, so that a relevant user may be informed of the accurate task execution state by directly accessing the data center.

Further, the data center involved in the above embodiment includes a cloud data center based on a software as a service (SaaS) framework. Compared to an IaaS (Infrastructure as a service) framework and a PaaS (Platform as a service) framework, adoption of the SaaS may bring better user experience in the current application scenario.

It should be understood that the number of user terminals, networks, quantum hardware clients, or superconducting quantum computers in FIG. 1 is merely schematic. There may be any number of user terminals, networks, quantum hardware clients, and superconducting quantum computers depending on implementation needs.

In order to deepen the understanding of the overall implementation scheme, the user terminal, the quantum hardware client, and the superconducting quantum computer will be used as executing bodies respectively, to describe the respective execution schemes from the perspectives of the executing bodies respectively as follows.

First, referring to FIG. 2, FIG. 2 is a flowchart of a method for processing a quantum task applied to a user terminal provided by an embodiment of the present disclosure. That is, the executing body of each of the following steps in the present embodiment is the user terminal (e.g., the user terminals 101, 102 shown in FIG. 1) constituting the system for processing a quantum task, where a flow 200 includes the following steps.

Step 201 includes: acquiring basic measurement and control parameters of a superconducting quantum computer;

This step intends to acquire the basic measurement and control parameters of the superconducting quantum computer by the user terminal. First, the user terminal initiates a quantum task generation request under control of a user, then the matching superconducting quantum computer (e.g., the superconducting quantum computer 105 as shown in FIG. 1) may be determined based on the quantum task generation request (if there are multiple different superconducting quantum computers, a target superconducting quantum computer corresponding to the request may be determined in this regard; if there is only one superconducting quantum computer, i.e., this one is the superconducting quantum computer matching the request), and the basic measurement and control parameters of the matching superconducting quantum computer may be acquired. That is, different superconducting quantum computers may have different basic measurement and control parameters due to differences in physical parameters.

In particular, the basic measurement and control parameters may include: a definition of the quantum pulse gate, time axis arrangement and bit distribution information, the quantum pulse gate is jointly defined by a pulse waveform function and pulse parameters, the pulse waveform function is used to describe a corresponding pulse waveform, and the pulse parameters include: a target frequency of a pulse, an arbitrary waveform generator frequency, a phase, an amplitude scaling coefficient, start time, a duration, and distinctive parameters corresponding to different pulse waveform functions. That is, performance and properties of the superconducting quantum computer are represented by the above parameters, in order to facilitate the generation of quantum tasks that can be recognized and operated properly by the superconducting quantum computer on this basis.

Further, when the superconducting quantum computer can establish a direct data communication link with the user terminal, the basic measurement and control parameters may be returned by the superconducting quantum computer in response to the quantum task generation request transmitted by the user terminal; in consideration of the fact that it is usually not appropriate for the superconducting quantum computer to establish a direct data communication link with the user terminal, the basic measurement and control parameters may alternatively be returned to the user terminal by a quantum hardware client (e.g., the quantum hardware client 104 as shown in FIG. 1) pre-storing the bound superconducting quantum computer, in response to the quantum task generation request transmitted by the user terminal. In this case, the quantum hardware client also needs to periodically synchronize latest basic measurement and control parameters of the superconducting quantum computer, to ensure the validity of the basic measurement and control parameters returned to the user terminal.

Step 202 includes: generating a quantum task consisting of a quantum pulse and a quantum pulse gate based on the basic measurement and control parameters and an intended task purpose,

On the basis of step 201, this step intends to generate by the user terminal the quantum task consisting of the quantum pulse and the quantum pulse gate based on the basic measurement and control parameters and the intended task purpose. The quantum pulse gate is obtained by encapsulating an underlying-level pulse form corresponding to a quantum gate circuit at a logic level.

That is, each different quantum gate circuit actually corresponds to a respective quantum pulse form, and the quantum pulse gate is obtained by encapsulating the underlying-level complete pulse form corresponding to the quantum gate circuit at the logic level in the present disclosure, thus enabling deepening quantum task content, which is previously expressed only at the logic level, into a quantum pulse level lower than the logic level.

Here, the intended task purpose may include: a user-defined number of repeat use, and/or an approach of processing in-phrase and quadrature signals.

Step 203 includes: sending the quantum task to a quantum hardware client, and receiving a task result returned by the superconducting quantum computer after the superconducting quantum computer executes a quantum pulse sequence obtained by parsing the quantum task by the quantum hardware client.

On the basis of step 202, this step intends to send the quantum task to the quantum hardware client, and receive the task result returned by the superconducting quantum computer after the superconducting quantum computer executes the quantum pulse sequence obtained by parsing the quantum task by the quantum hardware client.

Further, the task result may alternatively be forwarded to the user terminal by the superconducting quantum computer through its pre-set quantum hardware client.

According to the method for processing a quantum task applied to a user terminal provided in this embodiment of the present disclosure, when a quantum task is constructed at the user terminal, first the quantum task consisting of a quantum pulse and a quantum pulse gate is generated based on basic measurement and control parameters of a superconducting quantum computer to be used subsequently and the experimental purpose of the user terminal. Since the quantum pulse gate is obtained by encapsulating an underlying-level pulse form corresponding to a quantum gate circuit at the logic level, the constructed quantum task can be expressed in a lower level, allowing a more specific set at the quantum pulse level. At the same time, the quantum hardware client at the front-end of the superconducting quantum computer provides a parsing and processing capability matching the quantum task, thus achieving a finer control of execution parameters in the quantum task, enabling superconducting quantum devices to perform the task more accurately according to the quantum pulse instructions, so that an obtained task result can more closely match the user task expectations, improving an accuracy of the task result.

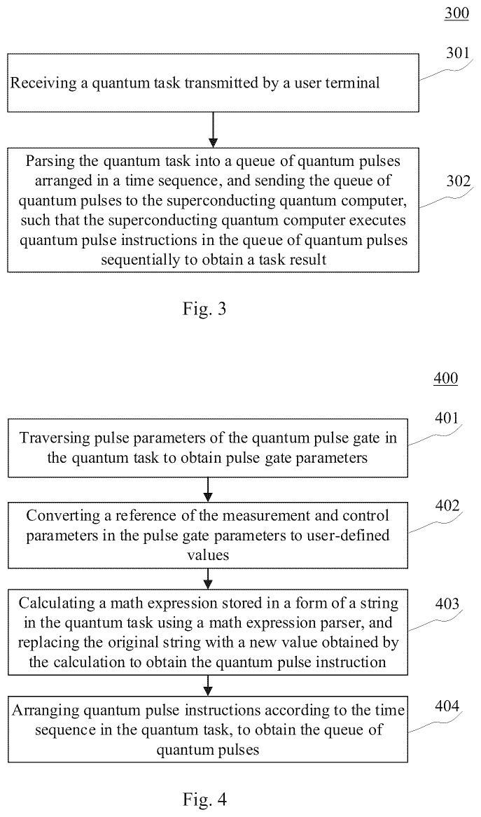

Distinguishing from the embodiment of the method for processing a quantum task applied to a user terminal shown in FIG. 2, referring to FIG. 3, FIG. 3 is a flowchart of a method for processing a quantum task applied to a quantum hardware client provided by an embodiment of the present disclosure. That is, the executing body of each of the following steps in the present embodiment is the quantum hardware client (e.g., the quantum hardware client 104 shown in FIG. 1) constituting the system for processing a quantum task, where a flow 300 includes the following steps.

Step 301 includes: receiving a quantum task transmitted by a user terminal; and

This step intends to receive by the quantum hardware client the compiled quantum task transmitted by the user terminal. With regard to how the quantum task is generated and obtained by the user terminal, reference may be made to above detailed description of the embodiment shown in FIG. 2, which is omitted herein.

Step 302 includes: parsing the quantum task into a queue of quantum pulses arranged in a time sequence, and sending the queue of quantum pulses to the superconducting quantum computer, such that the superconducting quantum computer executes quantum pulse instructions in the queue of quantum pulses sequentially to obtain a task result.

On the basis of step 301, this step intends to parse by the quantum hardware client the quantum task into the queue of quantum pulses arranged in the time sequence and can be recognized and executed properly by the superconducting quantum computer. That is, the queue of quantum pulses is obtained by arranging a plurality of quantum pulse instructions in the execution time sequence, so as to enable the superconducting quantum computer to obtain the task result desired by the user after sequentially executing quantum pulse instructions in the queue of quantum pulses.

The method for processing a quantum task applied to a quantum hardware client provided in this embodiment of the present disclosure, in order to match the quantum task consisting of a quantum pulse and a quantum pulse gate generated by the user terminal, the quantum hardware client at the front-end of the superconducting quantum computer also provides a parsing and processing capability matching the quantum task, so that the quantum task can be parsed into a queue of quantum pulses that can be recognized and executed properly by the superconducting quantum computer, thus enabling superconducting quantum devices to perform the task more accurately according to the quantum pulse instructions, so that the task result is more in line with the user actual needs.

In particular, parsing the quantum task by the quantum hardware client may be performed in a variety of methods, the following is a specific embodiment provided in FIG. 4, where a flow 400 includes the following steps.

Step 401 includes: traversing pulse parameters of the quantum pulse gate in the quantum task to obtain pulse gate parameters.

This step intends to traverse the pulse parameters of each quantum pulse gate in the quantum task by the quantum hardware client, to obtain the pulse gate parameters.

Step 402 includes: converting a reference of the measurement and control parameters in the original pulse gate parameters to user-defined values.

On the basis of step 401, this step intends to convert by the quantum hardware client the reference of the measurement and control parameters in the original pulse gate parameters to the user-defined values, to guarantee that the user customized settings do take effect.

Step 403 includes: calculating a math expression stored in a form of a string in the quantum task by using a math expression parser, and replacing the original string with a new value obtained by the calculation to obtain the quantum pulse instruction.

On the basis of step 402, this step intends to calculate by the quantum hardware client the math expression stored in the form of a string in the quantum task by using the math expression parser, and replace the original string with the new value obtained by the calculation, to obtain the quantum pulse instruction.

Here, the math expression parser (MEP) is a tool for parsing data expressions, used in actual project development if a math formula needs to be parsed, such as the common Expression4J, or Jep.

Expression4J is a Java-based open-source framework, which is used manipulating math expressions and is a math formula parser. In Expression4J, a math expression may be stored in a string object, such as “f(x,b)=2*x−cos(b)” and “g(x,y)=f(y,x)*−2”. Expression4J is highly customized, in which a user may customize grammars, its main function includes basic mathematical operations on real and complex numbers, support for basic mathematical functions (functions such as sin, cos), complex functions (e.g., f(x)=2*x+5, g(x)=3*f(x+2)−x, etc.), as well as user-defined functions and grammars using the Java language, and Expression4J can define function catalogs (function sets), support XML configuration files, and so on.

Jep (JavaMathematical Expression Parser) is a Java class library for parsing and solving math expressions. By using packages provided by Jep, an arbitrary math formula expressed as a string may be entered and then solved immediately. Jep supports user-defined variables, constants, and user-defined functions, and also contains a large number of general-purpose math functions and constants.

Step 404 includes: arranging quantum pulse instructions according to the time sequence in the quantum task, to obtain the queue of quantum pulses.

On the basis of step 403, this step intends to arrange by the above executing body quantum pulse instructions according to the time sequence in the quantum task, to obtain the queue of quantum pulses.

That is, the present embodiment gives an implementation scheme of how to parse a quantum task containing user-defined values and a math expression in the form of a string into a queue of quantum pulses through the above steps, which is achieved by making full use of traversal, user-defined value replacement, and the math expression parser, and has high efficiency and accuracy in practice.

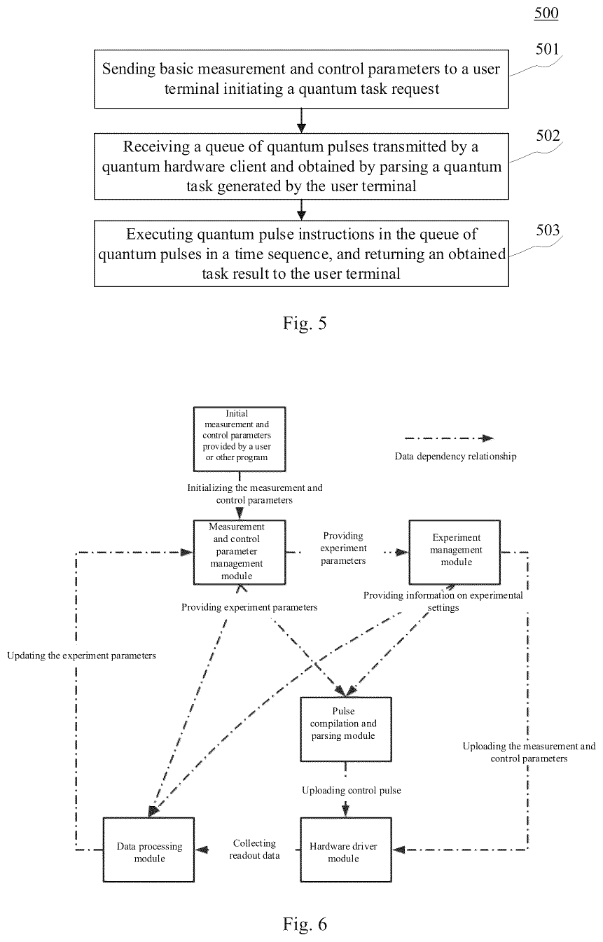

Distinguishing from the embodiment of the method for processing a quantum task applied to a user terminal shown in FIG. 2, and the embodiment of the method for processing a quantum task applied to a quantum hardware client shown in FIGS. 3-4, referring to FIG. 5, FIG. 5 is a flowchart of a method for processing a quantum task applied to a superconducting quantum computer provided by an embodiment of the present disclosure. That is, the executing body of each of the following steps in the present embodiment is the superconducting quantum computer (e.g., the superconducting quantum computer 105 shown in FIG. 1) constituting the system for processing a quantum task, where a flow 500 includes the following steps.

Step 501 includes: sending basic measurement and control parameters to a user terminal that initiates a quantum task request.

That is, this step intends to return by the superconducting quantum computer the basic measurement and control parameters of the superconducting quantum computer to the user terminal that initiates the quantum task request, and in particular, the basic measurement and control parameters may be forwarded to the user terminal via a quantum hardware client.

Step 502 includes: receiving a queue of quantum pulses transmitted by a quantum hardware client and obtained by parsing a quantum task generated by the user terminal.

On the basis of step 501, this step intends to receive by the superconducting quantum computer the queue of quantum pulses transmitted by the quantum hardware client and obtained by parsing a quantum task generated by the user terminal.

With regard to how the queue of quantum pulses is obtained by using the quantum hardware client to parse the quantum task generated by the user terminal, reference may be made to the relevant detailed description in the above embodiment using the quantum hardware client as the executing body, which is omitted herein.

Step 503 includes: executing quantum pulse instructions in the queue of quantum pulses in a time sequence, and returning an obtained task result to the user terminal.

On the basis of step 502, this step intends to execute quantum pulse instructions in the queue of quantum pulses in the time sequence, and return the obtained task result to the user terminal by the superconducting quantum computer.

With the method for processing a quantum task applied to a superconducting quantum computer provided in this embodiment of the present disclosure, by returning the basic measurement and control parameters of the superconducting quantum computer to the user terminal that initiates the quantum task request, the user terminal generates the quantum task consisting of a quantum pulse and a quantum pulse gate based on the basic measurement and control parameters, and by receiving the queue of quantum pulses parsed by the quantum hardware client, the superconducting quantum computer is able to perform the task more accurately according to the quantum pulse instructions, so as to make an obtained task result more closely match the task expectations of the user, improving the accuracy of the task result.

On the basis of the above embodiment, a data center may alternatively be added to the system for processing a quantum task, i.e., the data center is arranged at a communication link between the user terminal and the quantum hardware client, in order to serve as a data forwarding platform and an additional data processing and access portal, for providing a more comprehensive data forwarding, processing and monitoring capability.

That is, in this regard, the data center is configured to forward the basic measurement and control parameters of the superconducting quantum computer transmitted via the quantum hardware client to the user terminal; forward the quantum task received from the user terminal to the quantum hardware client; and forward a task result received from the quantum hardware client to the user terminal.

In addition, the data center may be further configured to create a corresponding task item based on the received quantum task; and adjust an execution state of the corresponding task item based on the received task result; where the execution state includes: a to-be-executed state and an executed state.

For a deeper understanding, the present disclosure also proposes, in conjunction with a specific application scenario, a measurement and control experiment implementation software scheme applied to a superconducting quantum computer. This scheme splits functions required to accomplish the superconducting quantum computer into multiple standard functional modules, which are invoked in different devices, and the different devices communicate with each other through a modern network protocol.

In this scheme, a conventional operation on a stand-alone computer is split. A user client uses standard modules to generate instructions, while specific algorithms for realizing a quantum computing measurement and control experiment are implemented on a server-side (SaaS data center and quantum hardware client), so that a user may submit measurement and control requirements by means of constructing an instruction, and the server-side may adopt the algorithm according to the instruction, thus constituting an organic and reliable cloud measurement and control architecture that integrates instructions, algorithms, and adaptations.

First, the functional modules involved in this scheme will be described, followed by types of devices required in the scheme and dependency relationships between the modules, finally, working steps at the client will be described.

### Standard Functional Modules

Since real quantum computing experimental setups are often very complex, this scheme defines standard, highly cohesive functional modules to standardize the invoking of multiple functions including measurement and control parameter management, experiment management, pulse compilation, and experiment result management, so that the same function may be realized by invoking the same module throughout the entire system (different devices), thus reducing development and user learning costs and facilitating the access to data. A measurement and control software platform for the superconducting quantum computer in this scheme mainly includes the following functional modules.

(1) Measurement and Control Parameter Management Module/Service

In the client, the user uses the measurement and control parameter management module to communicate with the measurement and control parameter management service in the SaaS data center, reads and edits all parameters required for measurement and control; in the quantum hardware client, a program may read these parameters from the SaaS data center, use them for pulse compilation and set parameters required for the hardware. Managed parameters include, but are not limited to:
1. Basic equipment information: including but not limited to dilution chiller cooling time, equipment description, a coupling structure of bit and coupler, pulse compilation and configuration information, etc.;
2. Device control channel configuration and chip information: chip structure, device number, device hardware channel and quantum bit channel mapping relationship, etc.;
3. Device input and output parameters: device input or output power, control pulse delay, local oscillator frequency, etc.;
4. Definition of quantum gate parameters: pulse parameter calibration information for the single-bit quantum gate and the two-bit quantum gate supported by the system, etc.;
5. Quantum bit parameter information: quantum bit basic physical information, minimum/maximum/working frequency, readout cavity information, bit cavity frequency modulation period, bit type, etc.;

(2) Experiment Management Module/Service

The user edits all information required for a complete experiment using the function provided by this module in the client, the client communicates with the experiment management service in the SaaS data center after the definition is completed and uploads experiment information, and the SaaS data center assigns the task to a selected hardware client to run. When receiving the experiment information, the hardware client parses the information using the experiment management module, and provides information required for pulse compilation for a pulse compilation and parsing module.

Information needed by the experiment management module includes, but is not limited to:
1. Complete measurement and control parameters of the current device, which may be derived from the measurement and control parameter management module, or may be temporarily added measurement and control parameters in this experiment or measurement and control parameters temporarily overwriting the existing measurement and control parameters in this experiment;
2. Providing definitions based on the pulse gate, time axis arrangement (horizontal), and bit distribution (vertical) information;
3. The basic measurement and control parameters include: a definition of the quantum pulse gate, time axis arrangement and bit distribution information, the quantum pulse gate is jointly defined by a pulse waveform function and pulse parameters, the pulse waveform function is used to describe a corresponding pulse waveform, and the pulse parameters include: a target frequency of a pulse, an arbitrary waveform generator frequency, a phase, an amplitude scaling coefficient, start time, a duration, and distinctive parameters corresponding to different pulse waveform functions;
4. User-defined setting information, including but not limited to: a user-defined number of repeat use, an approach of processing in-phrase and quadrature signals, etc.;
5. Setting scanning instructions for zero, one or more of the above pulse parameters; and
6. Experiment text description information.

(3) Pulse Compilation and Parsing Module

The pulse compilation and parsing module runs in the hardware client, which combines the measurement and control parameters and experiment setup data to compile the pulse gate into a pulse sequence, and this module provides methods for experiment parsing and pulse compilation as follows:
1. Pulse parameter parsing function: traversing pulse gate parameters in the experiment, converting a reference of the measurement and control parameters in the gate parameters into a user setup value, and calculating a math expression stored in a string using a “math expression parser”, and replacing the original string with the calculated value.
2. Scanning instruction parsing function: traversing the pulse gate parameters in the experiment, parsing a scanning instruction in the experiment using a “scanning instruction parser”, for storing in the form of an index.
3. Pulse compilation and generation: traversing the pulse gates in the experiment, and merging pulses in these pulse gates into one complete pulse. If the current experiment contains a scanning experiment, then traversing scanning setup, and outputting one or more sets of complete pulses cyclically.

(4) Hardware Driver Module

The module is used to connect a room temperature control device of the superconducting quantum computer, transmit the measurement and control parameters and the compiled pulse sequence to the hardware device through the specific protocol, send hardware device control instructions, and receive returned data from the hardware device.

The hardware driver module needs to realize an interface with the “pulse compilation and parsing module”, the “measurement and control parameter management module” and the “experiment management module”, therefore, this module is also a main entrance for interfacing with the hardware by the components of the measurement and control software platform.

(5) Data Processing Module

The experiment result data processing module is used in the user client for processing and analyzing an experiment result. The module mainly includes the following functions:
1. converting an experiment return result into structured data, based on experiment information generated by an experiment construction module;
2. plotting based on the structured data;
3. invoking a user-defined program to fit and process the data, based on the structured data and the experiment information.

Data dependency relationships between the above functional modules are as shown in FIG. 6.

In order to provide remote, multi-user, highly available measurement and control services at the devices, this scheme includes the highly available SaaS data center, which is used to persistently store data and provide continuous network and data services for the user client and the hardware client. The hardware client is the interface to the underlying physical implementation of a superconducting quantum computing task, which not only needs to connect to the hardware devices performing quantum computing to execute the quantum experiment task, but also needs to connect to the SaaS data center to pull a full definition of the experiment task and data such as the measurement and control parameters. The user client is the entrance for experimenters and an application layer, the user may set up experiments through the user client and submits complete experiment setup data and measurement and control parameter data to the SaaS data center, so as to realize control of the quantum hardware devices.

This scheme mainly contains the following devices:

(1) Experiment and Application Client

The client includes the experiment construction module, the experiment result data processing module, the measurement and control parameter management module, and provides corresponding network interfaces, which enables the user to communicate with a hub server. The interface includes, but is not limited to, a visualization graphical interface, and other applications developed based on an API (Application Programming Interface) interface, and mainly provides the following functions:
1. communicating with the SaaS data center via the network interface using the measurement and control parameter management module, to read and modify instructions on the measurement and control parameters;
2. constructing an experiment using the experiment construction module, and submitting task construction to the SaaS data center via the network interface, and sending instructions on task running;
3. pulling an experiment result from the SaaS data center via the network interface, and processing the data using the experiment result data processing module.

(2) SaaS Data Center

The SaaS data center may provide highly available application and storage services, providing technical guarantee for multi-user concurrent access to measurement and control services, breaking through the limitations of existing software that usually adopts a “single-point architecture” and cannot be accessed by multiple users at the same time. The SaaS data center may be deployed on a public cloud server or privately deployed; therefore, the client may access the data center via cross-domain or local area networks. Main functions of the data center include:
1. providing storage and access services of the measurement and control parameters for the quantum hardware client and the application client;
2. providing storage and access of experiment construction data for the quantum hardware client and the application client; where the user client may upload the experiment, and the hub server maintains the queue and distributes the experiment to the quantum hardware client;
3. providing the user client with an access function to a resource ID list of an experiment result file in a file server, and allowing the quantum hardware client to upload the resource ID list;
4. The file server is mainly used to store large volume of data, mainly for experiment result data. The file server mainly provides the following functions:
a. providing an experiment result upload function for the quantum hardware client and returning a resource ID; and
b. providing the user client with a function of downloading the experiment result file by using the resource ID list.
5. User management service: for managing access rights of users.

(3) Quantum Hardware Client

The quantum hardware client needs to receive experiment operation instructions, the experiment construction data, and the measurement and control parameters from the SaaS data center, and is directly connected to the room temperature control device. The hardware client is responsible for compiling and controlling the pulse sequence, interfacing with the room temperature control device, and sending a control pulse to the room temperature control device through the hardware driver module. Then, the room temperature control device generates a physical signal to control a quantum processing unit (QPU) inside the dilution chiller, and reads a measurement return result.

After obtaining the measurement return result, the quantum hardware client uploads the measurement result to the file server to acquire the resource ID and return it to the SaaS data center.

(4) Superconducting Quantum Computer Hardware Facilities

Generally, the hardware facilities of the superconducting quantum computer consist of the room temperature control device, the dilution chiller, and a quantum chip. The quantum hardware client is connected to the room temperature control device through a drive program to generate control signals and collect readout signals.

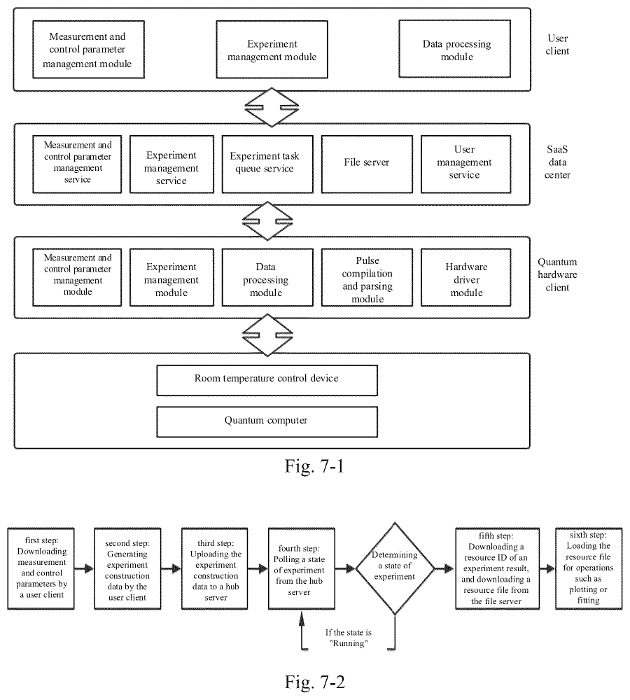

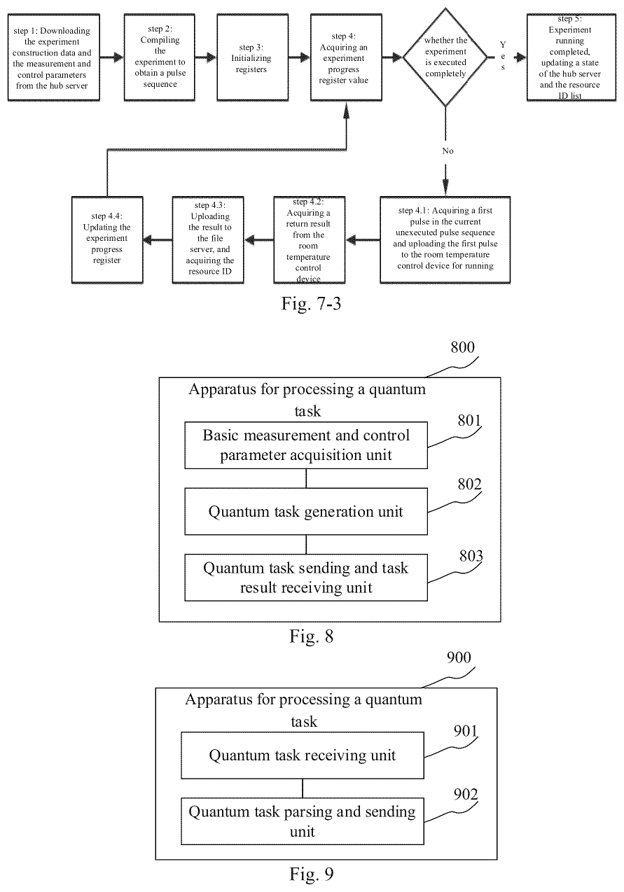

The inclusion relationships and interfaces of the modules and devices in this scheme are shown in FIG. 7-1.

In this scheme, the user client and the SaaS data center adopt an asynchronous communication mode, since asynchronous communication does not lead to server blocking.

Client Working Steps

For different roles, there are different methods of using this system, the system herein mainly includes the user client and the quantum hardware client, which will be described separately.

User Client

The user client mainly provides access entrances for pulse layer experimenters or application layer users, and the working steps of access by pulse layer experimenters or application layer users are the same, as following steps:
1) downloading the measurement and control parameters using the measurement and control parameter management module in the user client by the user;
2) combining the measurement and control parameters, performing an experiment using the experiment construction module to generate the experiment construction data;
3) uploading the experiment construction data to the experiment management service in the SaaS data center;
4) polling a state of the experiment task from the experiment management service in the SaaS data center, waiting 0.5 seconds and then re-executing step 4), if the state of the experiment task is “running”; and proceeding to step 5) if the state is “completed”;
5) downloading an experiment result resource ID from the experiment management service in the SaaS data center, and downloading the experiment result file from the file server in the SaaS data center based on the resource ID.
6) loading the experiment result file using the experiment result data processing module and performing data processing operations such as plotting or fitting.

Referring to FIG. 7-2 for a workflow schematic diagram of the user client.

Quantum Hardware Client

The quantum hardware client is used to connect to the hardware devices, and is responsible for executing the experiment task which is set and uploaded by the user and for returning the experiment result. The working steps are as follows:
1): downloading the experiment construction data and the measurement and control parameters from an experiment task queue service in the SaaS data center;
2): parsing the experiment construction data into one or more sets of pulse sequences using the pulse compilation and parsing module, based on parameter scan settings;
3): initializing an integer register to record an experiment progress, initializing a measurement result register, and a resource ID register;
4): if an integer recorded in the integer register is greater than a maximum number of pulses in the pulse sequence, skipping to step 5), if the integer recorded in the integer register is not greater than the maximum number of pulses in the pulse sequence, running step 4.1);
4.1): taking a next pulse from the pulse sequence, and sending the pulse to the room temperature control device through the hardware driver module and running the pulse on the superconducting quantum computer;
4.2): downloading the measurement return result from the room temperature control device using the hardware driver module and storing the result to the register.
4.3): uploading data in the register to the file server, and storing the experiment state and the resource ID to the resource ID register, and uploading the latest resource ID recorded in the resource ID register to the hub server;
4.4): setting a value of the integer register to be incremented by one step, and returning to step 4);
5) finishing the experiment operation, and uploading the task state and the resource ID list to the hub server.

A workflow schematic diagram of the quantum hardware client is referred to FIG. 7-3.

With further reference to FIG. 8 to FIG. 10, as an implementation of the methods shown in the above figures, the present disclosure provides an embodiment of an apparatus for processing a quantum task applied to a user terminal, an embodiment of an apparatus for processing a quantum task applied to a quantum hardware client and an embodiment of an apparatus for processing a quantum task applied to a superconducting quantum computer. The embodiment of the apparatus for processing a quantum task applied to a user terminal corresponds to the embodiment of the method for processing a quantum task applied to a user terminal shown in FIG. 2, the embodiment of the apparatus for processing a quantum task applied to a quantum hardware client corresponds to the embodiment of the method for processing a quantum task applied to a quantum hardware client shown in FIG. 4, and the embodiment of the apparatus for processing a quantum task applied to a superconducting quantum computer corresponds to the embodiment of the method for processing a quantum task applied to a superconducting quantum computer shown in FIG. 6.

The above apparatuses may be applied in various electronic devices.

As shown in FIG. 8, the apparatus for processing a quantum task 800 applied to a user terminal in the present embodiment may include: a basic measurement and control parameter acquisition unit 801, a quantum task generation unit 802, and a quantum task sending and task result receiving unit 803. The basic measurement and control parameter acquisition unit 801 is configured to acquire basic measurement and control parameters of a superconducting quantum computer. The quantum task generation unit 802 is configured to generate a quantum task consisting of a quantum pulse and a quantum pulse gate based on the basic measurement and control parameters and an intended task purpose; where the quantum pulse gate is obtained by encapsulating an underlying-level pulse form corresponding to a quantum gate circuit at a logic level. The quantum task sending and task result receiving unit 803 is configured to send the quantum task to a quantum hardware client, and receive a task result returned by the superconducting quantum computer after the superconducting quantum computer executes a quantum pulse sequence obtained by parsing the quantum task using the quantum hardware client.

In the present embodiment, in the apparatus for processing a quantum task 800: for the specific processing and the technical effects of the basic measurement and control parameter acquisition unit 801, the quantum task generation unit 802, and the quantum task sending and task result receiving unit 803, reference may be made to the relevant descriptions of steps 201-203 in the corresponding embodiment of FIG. 2, respectively, detailed description thereof is omitted.

In some alternative implementations of the present embodiment, the intended task purpose includes: a user-defined number of repeat use and/or an approach of processing in-phrase and quadrature signals.

As shown in FIG. 9, the apparatus for processing a quantum task 900 applied to a quantum hardware client in the present embodiment may include: a quantum task receiving unit 901 and a quantum task parsing and sending unit 902. The quantum task receiving unit 901 is configured to receive a quantum task transmitted by a user terminal; where the quantum task is generated by the user terminal based on basic measurement and control parameters of a superconducting quantum computer and an experimental purpose of the user terminal, the quantum task consists of a quantum pulse and a quantum pulse gate, and the quantum pulse gate is obtained by encapsulating an underlying-level pulse form corresponding to a quantum gate circuit at a logic level. The quantum task parsing and sending unit 902 is configured to parse the quantum task into a queue of quantum pulses arranged in a time sequence, and send the queue of quantum pulses to the superconducting quantum computer, such that the superconducting quantum computer executes quantum pulse instructions in the queue of quantum pulses sequentially to obtain a task result.

In the present embodiment, in the apparatus for processing a quantum task 900: for the specific processing and the technical effects of the quantum task receiving unit 901 and the quantum task parsing and sending unit 902, reference may be made to the relevant descriptions of steps 301-302 in the corresponding embodiment of FIG. 3, respectively, detailed description thereof is omitted.

In some alternative implementations of the present embodiment, the quantum task parsing and sending unit 902 may include a quantum task parsing subunit configured to parse the quantum task into the queue of quantum pulses arranged in the time sequence, and the quantum task parsing subunit is further configured to:
traverse pulse parameters of the quantum pulse gate in the quantum task to obtain pulse gate parameters;
convert a reference of the measurement and control parameters in the pulse gate parameters to user-defined values;
calculate a math expression stored in a form of a string in the quantum task using a math expression parser, and replace the original string with a new value obtained by the calculation to obtain the quantum pulse instruction; and
arrange quantum pulse instructions according to the time sequence in the quantum task, to obtain the queue of quantum pulses.

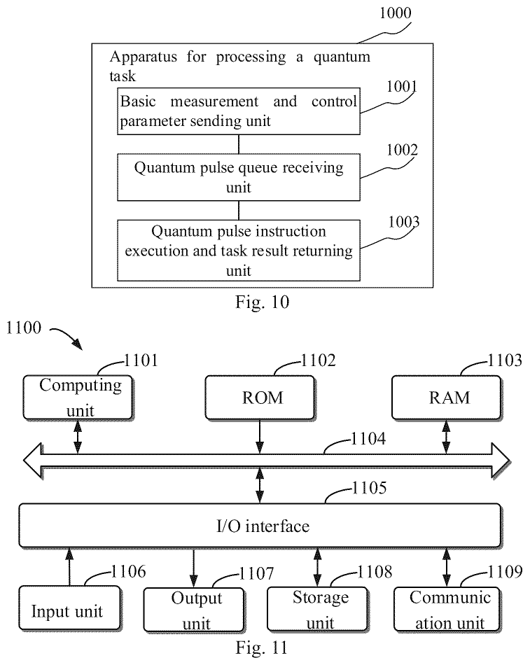

As shown in FIG. 10, the apparatus for processing a quantum task 1000 applied to a superconducting quantum computer in the present embodiment may include: a basic measurement and control parameter sending unit 1001, a quantum pulse queue receiving unit 1002, and a quantum pulse instruction execution and task result returning unit 1003. The basic measurement and control parameter sending unit 1001 is configured to send basic measurement and control parameters to a user terminal that initiates a quantum task request. The quantum pulse queue receiving unit 1002 is configured to receive a queue of quantum pulses transmitted by a quantum hardware client and obtained by parsing a quantum task generated by the user terminal; where the quantum task is generated by the user terminal based on the basic measurement and control parameters and an experimental purpose of the user terminal, the quantum task consists of a quantum pulse and a quantum pulse gate, and the quantum pulse gate is obtained by encapsulating an underlying-level pulse form corresponding to a quantum gate circuit at a logic level. The quantum pulse instruction execution and task result returning unit 1003 is configured to execute quantum pulse instructions in the queue of quantum pulses in a time sequence, and return an obtained task result to the user terminal.

In the present embodiment, in the apparatus for processing a quantum task 1000: for the specific processing and the technical effects of the basic measurement and control parameter sending unit 1001, the quantum pulse queue receiving unit 1002, and the quantum pulse instruction execution and task result returning unit 1003, reference may be made to the relevant descriptions of steps 501-503 in the corresponding embodiment of FIG. 5, respectively, detailed description thereof is omitted.

In some alternative implementations of the present embodiment, the basic measurement and control parameters include: a definition of the quantum pulse gate, time axis arrangement and bit distribution information, the quantum pulse gate is jointly defined by a pulse waveform function and pulse parameters, the pulse waveform function is used to describe a corresponding pulse waveform, and the pulse parameters include: a target frequency of a pulse, an arbitrary waveform generator frequency, a phase, an amplitude scaling coefficient, start time, a duration, and distinctive parameters corresponding to different pulse waveform functions.

The present embodiment serves as an apparatus embodiment corresponding to the above method embodiment. With the apparatus for processing a quantum task provided in the present embodiment, by deeply constructing an underlying layer of a quantum task, a user may construct the quantum task consisting of a quantum pulse and a quantum pulse gate based on basic measurement and control parameters and an intended task purpose, and at the same time, the quantum hardware client at a front-end of the superconducting quantum computer provides a parsing and processing capability matching the quantum task, thus achieving a finer control of execution parameters in the quantum task, enabling superconducting quantum devices to perform the task more accurately according to the quantum pulse instructions, so that a task result is more in line with the user actual needs.

According to an embodiment of the present disclosure, the present disclosure also provides an electronic device, the electronic device including: at least one processor; and a memory communicatively connected to the at least one processor; where the memory stores instructions executable by the at least one processor, and the instructions, when executed by the at least one processor, cause the at least one processor to implement a method for processing a quantum task described in any one of the above embodiments.

According to an embodiment of the present disclosure, the present disclosure also provides a readable storage medium storing computer instructions, where the computer instructions are used to cause the computer to implement a method for processing a quantum task described in any one of the above embodiments.

According to an embodiment of the present disclosure, the present disclosure also provides a computer program product, including a computer program, where the computer program, when executed by a processor, implements a method for processing a quantum task described in any one of the above embodiments.

FIG. 11 illustrates a schematic block diagram of an example electronic device 1100 that may be used to implement embodiments of the present disclosure. The electronic device is intended to represent various forms of digital computers, such as, laptops, desktop computers, workstations, personal digital assistants, servers, blade servers, mainframe computers, and other suitable computers. The electronic device may also represent various forms of mobile apparatuses such as, personal digital processors, cellular phones, smartphones, wearable devices, and other similar computing apparatuses. The components shown herein, their connections and relationships, and their functionality are intended as examples only, and are not intended to limit the implementations of the present disclosure described and/or claimed herein.

As shown in FIG. 11, the device 1100 includes a computing unit 1101 which may perform various appropriate actions and processes based on a computer program stored in a read-only memory (ROM) 1102 or loaded from a storage unit 1108 into a random access memory (RAM) 1103. In the RAM 1103, various programs and data required for operation of the device 1100 may also be stored. The computing unit 1101, the ROM 1102, and the RAM 1103 are connected to each other via a bus 1104. An input/output (I/O) interface 1105 is also connected to the bus 1104.

A plurality of components of the device 1100 are connected to the I/O interface 1105, including: an input unit 1106, such as a keyboard, or a mouse; an output unit 1107, such as various types of monitors, or speakers; the storage unit 1108, such as a disk, or a CD-ROM; and a communication unit 1109, such as a network card, a modem, or a wireless communication transceiver. The communication unit 1109 allows the device 1100 to exchange information/data with other devices via a computer network such as the Internet and/or various telecommunication networks.

The computing unit 1101 may be various general-purpose and/or dedicated processing components having processing and computing capabilities. Some examples of the computing unit 1101 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 1101 performs the various methods and processes described above, such as a method for processing a quantum task. For example, in some embodiments, a method for processing a quantum task may be implemented as a computer software program, which is tangibly included in a machine readable medium, such as the storage unit 1108. In some embodiments, part or all of the computer program may be loaded and/or installed on the device 1100 via the ROM 1102 and/or the communication unit 1109. When the computer program is loaded into the RAM 1103 and executed by the computing unit 1101, one or more steps of the method for processing a quantum task described above may be performed. Alternatively, in other embodiments, the computing unit 1101 may be configured to perform a method for processing a quantum task by any other appropriate means (for example, by means of firmware).

Various embodiments of the systems and technologies described above can be implemented in digital electronic circuit system, integrated circuit system, field programmable gate array (FPGA), application specific integrated circuit (ASIC), application special standard product (ASSP), system on chip (SOC), complex programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer or other programmable apparatus for data processing such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with the user, the systems and techniques described herein may be implemented on a computer having: a display device for displaying information to the user (e.g., a CRT (cathode ray tube) or LCD (liquid crystal display) monitor); a keyboard and a pointing device (e.g., mouse or trackball), through which the user can provide input to the computer. Other kinds of devices can also be used to provide interaction with users. For example, the feedback provided to the user may be any form of sensory feedback (e.g., visual feedback, auditory feedback, or tactile feedback); and the input from the user can be received in any form (including acoustic input, voice input or tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, which is also known as a cloud computing server or a cloud host, and is a host product in a cloud computing service system to solve the defects of difficult management and weak service extendibility existing in conventional physical hosts and virtual private servers (VPS).

Beneficial effects are repeated according to the technical solution of the embodiments of the present disclosure.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific embodiments do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A system for processing a quantum task, comprising:
a user terminal, configured to acquire basic measurement and control parameters of a superconducting quantum computer; generate a quantum task consisting of a quantum pulse and a quantum pulse gate based on the basic measurement and control parameters and an intended task purpose; wherein the quantum pulse gate is obtained by encapsulating an underlying-level pulse form corresponding to a quantum gate circuit at a logic level; and send the quantum task to a quantum hardware client;
the quantum hardware client, configured to parse the quantum task into a queue of quantum pulses arranged in a time sequence, and send the queue of quantum pulses to the superconducting quantum computer; and
the superconducting quantum computer, configured to execute quantum pulse instructions in the queue of quantum pulses in the time sequence, and return an obtained task result to the user terminal.

2. The system according to claim 1, wherein the basic measurement and control parameters comprise: a definition of the quantum pulse gate, time axis arrangement and bit distribution information, the quantum pulse gate is jointly defined by a pulse waveform function and pulse parameters, the pulse waveform function is used to describe a corresponding pulse waveform, and the pulse parameters comprise: a target frequency of a pulse, an arbitrary waveform generator frequency, a phase, an amplitude scaling coefficient, start time, a duration, and distinctive parameters corresponding to different pulse waveform functions.

3. The system according to claim 1, wherein the system further comprises:
a data center arranged at a communication link between the user terminal and the quantum hardware client;
wherein the data center is configured to forward the basic measurement and control parameters of the superconducting quantum computer transmitted via the quantum hardware client to the user terminal; forward the quantum task received from the user terminal to the quantum hardware client; and forward the task result received from the quantum hardware client to the user terminal.

4. The system according to claim 3, wherein:
the data center is further configured to create a corresponding task item based on the received quantum task; and adjust an execution state of the corresponding task item based on the received task result; wherein the execution state comprises: a to-be-executed state and an executed state.

5. The system according to claim 3, wherein the data center comprises a cloud data center based on adoption of a software-as-a-service framework.

6. A method for processing a quantum task, applied to a user terminal, comprising:
acquiring basic measurement and control parameters of a superconducting quantum computer;
generating a quantum task consisting of a quantum pulse and a quantum pulse gate based on the basic measurement and control parameters and an intended task purpose; wherein the quantum pulse gate is obtained by encapsulating an underlying-level pulse form corresponding to a quantum gate circuit at a logic level; and
sending the quantum task to a quantum hardware client, and receiving a task result returned by the superconducting quantum computer after the superconducting quantum computer executes a quantum pulse sequence obtained by parsing the quantum task by the quantum hardware client.

7. The method according to claim 6, wherein the intended task purpose comprises: a user-defined number of repeat use and/or an approach of processing in-phrase and quadrature signals.

8. A method for processing a quantum task, applied to a quantum hardware client, comprising:
receiving a quantum task transmitted by a user terminal; wherein the quantum task is generated by the user terminal based on basic measurement and control parameters of a superconducting quantum computer and an experimental purpose of the user terminal, the quantum task consists of a quantum pulse and a quantum pulse gate, and the quantum pulse gate is obtained by encapsulating an underlying pulse form corresponding to a quantum gate circuit at a logic level; and
parsing the quantum task into a queue of quantum pulses arranged in a time sequence, and sending the queue of quantum pulses to the superconducting quantum computer, so as to enable the superconducting quantum computer to execute quantum pulse instructions in the queue of quantum pulses sequentially to obtain a task result.

9. The method according to claim 8, wherein the parsing the quantum task into a queue of quantum pulses arranged in a time sequence, comprises:
traversing pulse parameters of the quantum pulse gate in the quantum task to obtain pulse gate parameters;
converting a reference of the measurement and control parameters in the pulse gate parameters to a user-defined value;
calculating a math expression stored in a form of a string in the quantum task using a math expression parser, and replacing an original string with a new value obtained by the calculation to obtain the quantum pulse instruction; and
arranging quantum pulse instructions according to the time sequence in the quantum task, to obtain the queue of quantum pulses.

10. A method for processing a quantum task, applied to a superconducting quantum computer, comprising:
sending basic measurement and control parameters to a user terminal initiating a quantum task request;
receiving a queue of quantum pulses transmitted by a quantum hardware client and obtained by parsing a quantum task generated by the user terminal; wherein the quantum task is generated by the user terminal based on the basic measurement and control parameters and an experimental purpose of the user terminal, the quantum task consists of a quantum pulse and a quantum pulse gate, and the quantum pulse gate is obtained by encapsulating an underlying-level pulse form corresponding to a quantum gate circuit at a logic level; and
executing quantum pulse instructions in the queue of quantum pulses in a time sequence, and returning an obtained task result to the user terminal.

11. The method according to claim 10, wherein:
the basic measurement and control parameters comprise: a definition of the quantum pulse gate, time axis arrangement and bit distribution information, the quantum pulse gate is jointly defined by a pulse waveform function and pulse parameters, the pulse waveform function is used to describe a corresponding pulse waveform, and
the pulse parameters comprise: a target frequency of a pulse, an arbitrary waveform generator frequency, a phase, an amplitude scaling coefficient, start time, a duration, and distinctive parameters corresponding to different pulse waveform functions.

12. An electronic device, comprising:
at least one processor; and
a memory communicatively connected to the at least one processor;
wherein the memory stores instructions executable by the at least one processor, and the instructions, when executed by the at least one processor, cause the at least one processor to perform the method for processing a quantum task according to claim 6.

13. An electronic device, comprising:
at least one processor; and
a memory communicatively connected to the at least one processor;
wherein the memory stores instructions executable by the at least one processor, and the instructions, when executed by the at least one processor, cause the at least one processor to perform the method for processing a quantum task according to claim 8.

14. An electronic device, comprising:
at least one processor; and
a memory communicatively connected to the at least one processor;
wherein the memory stores instructions executable by the at least one processor, and the instructions, when executed by the at least one processor, cause the at least one processor to perform the method for processing a quantum task according to claim 10.

15. A non-transitory computer readable storage medium storing computer instructions, wherein the computer instructions are used to cause a computer to perform the method for processing a quantum task according to claim 6.

16. A non-transitory computer readable storage medium storing computer instructions, wherein the computer instructions are used to cause a computer to perform the method for processing a quantum task according to claim 8.

17. A non-transitory computer readable storage medium storing computer instructions, wherein the computer instructions are used to cause a computer to perform the method for processing a quantum task according to claim 10.
